(19) United States
(12) Patent Application Publication
(10) Pub. No.: US 2020/0404184 A1
(43) Pub. Date: Dec. 24, 2020

(54) IMAGING DEVICE, CONTROL METHOD, AND PROGRAM

(71) Applicant: FUJIFILM Corporation, Tokyo (JP)

(72) Inventors: Fuyuhiko MAEDA, Saitama-shi (JP); Yasuhiro MIWA, Saitama-shi (JP)

(73) Assignee: FUJIFILM Corporation, Tokyo (JP)

(21) Appl. No.: 17/010,461

(22) Filed: Sep. 2, 2020

Related U.S. Application Data
(63) Continuation of application No. PCT/JP2019/003859, filed on Feb. 4, 2019.

(30) Foreign Application Priority Data
Mar. 30, 2018 (JP) 2018-069131

(51) Int. Cl. H04N 5/232; G01D 5/14; G01K 1/02; H04N 5/225

(52) U.S. Cl. CPC H04N 5/23287; G01D 5/145; H04N 5/2253; H04N 5/2254; G01K 1/026

(57) ABSTRACT

The imaging device includes: a magnet; a Hall element that detects magnetism generated by the magnet; a substrate to which one of the magnet and the Hall element and an imaging element, which outputs a taken image obtained by taking an optical image transmitted through an imaging optical system, are fixed and which moves the position of the imaging element in directions perpendicular to an optical axis; a drive portion that drives the substrate; a fixing portion to which the other of the magnet and the Hall element is fixed and which is fixed to an imaging device body; and a body-side main controller that performs control to drive the substrate on the basis of the moving distance of the imaging element derived on the basis of the detection result of the Hall element, the temperature of the magnet, and the temperature of the Hall element.

### CROSS-REFERENCE TO RELATED APPLICATIONS

This application is a Continuation of PCT International Application No. PCT/JP2019/003859 filed on Feb. 4, 2019, which claims priority under 35 U.S.C § 119(a) to Japanese Patent Application No. 2018-069131 filed on Mar. 30, 2018. Each of the above application(s) is hereby expressly incorporated by reference, in its entirety, into the present application.

### BACKGROUND OF THE INVENTION

### 1. Field of the Invention

The present disclosure relates to an imaging device, a control method, and a non-transitory computer readable recording medium storing a program.

### 2. Description of the Related Art

Techniques for correcting camera shake at the time of imaging in an imaging device that takes the optical image of a subject are disclosed in the related art (see JP2013-088706A and JP2015-200797A).

In the techniques disclosed in JP2013-088706A and JP2015-200797A, a detection value of a detection unit provided to derive the amount of camera shake is subjected to correction corresponding to the internal temperature of a device.

### SUMMARY OF THE INVENTION

However, in the techniques disclosed in JP2013-088706A and JP2015-200797A, the amount of camera shake may not be appropriately derived in a case where the detection value is merely subjected to correction according to the internal temperature of the device in configuration for driving an imaging element in directions perpendicular to an optical axis to correct camera shake. Since the amount of camera shake to be derived has an inappropriate value in this case, the accuracy of the correction of camera shake is lowered.

The disclosure has been made in consideration of the above-mentioned circumstances, and an object of the disclosure is to provide an imaging device, a control method, and a non-transitory computer readable recording medium storing a program that can accurately correct camera shake in a case where imaging is performed.

In order to achieve the object, an imaging device according to a first aspect of the disclosure comprises: a magnetism generating portion; a magnetism detecting portion that detects magnetism generated by the magnetism generating portion; a moving portion to which one of the magnetism generating portion and the magnetism detecting portion and an imaging element, which outputs a taken image obtained by taking an optical image transmitted through an imaging optical system, are fixed and which moves a position of the imaging element in directions perpendicular to an optical axis of the imaging optical system; a drive portion that moves the moving portion; a fixing portion to which the other of the magnetism generating portion and the magnetism detecting portion is fixed and which is fixed to an imaging device body; a first temperature detection sensor that detects a temperature of the magnetism generating portion and outputs a detection result as a first temperature; a second temperature detection sensor that detects a temperature of the magnetism detecting portion and outputs a detection result as a second temperature; and a controller that performs control to move the moving portion by the drive portion on the basis of a moving distance of the imaging element derived on the basis of a detection result of the magnetism detecting portion, the first temperature, and the second temperature.

According to a second aspect, in the imaging device according to the first aspect, the controller may derive the moving distance on the basis of, additionally, an amount of deviation between a position of the magnetism generating portion and a position of the magnetism detecting portion that is measured in advance.

According to a third aspect, the imaging device according to the first or second aspect may further comprise a storage portion that stores a third temperature of the magnetism generating portion and a fourth temperature of the magnetism detecting portion which are temperatures measured respectively at a predetermined timing when imaging is not yet performed by the imaging element, and the controller may derive the moving distance of the moving portion on the basis of, additionally, the third temperature and the fourth temperature.

According to a fourth aspect, in the imaging device according to any one of the first to third aspects, the controller may perform control to move the moving portion by the drive portion on the basis of the moving distance and an amount of deviation of a predetermined position of a center of the taken image.

According to a fifth aspect, in the imaging device according to any one of the first to fourth aspects, the controller may include a circuit portion that perform offset correction on the detection result of the magnetism detecting portion on the basis of an amount of deviation between a position of the magnetism generating portion and a position of the magnetism detecting portion that is measured in advance.

According to a sixth aspect, in the imaging device according to any one of the first to fifth aspects, the magnetism detecting portion may be a Hall element.

A control method according to a seventh aspect is a control method for an imaging device. The imaging device includes a magnetism generating portion, a magnetism detecting portion that detects magnetism generated by the magnetism generating portion, a moving portion to which one of the magnetism generating portion and the magnetism detecting portion and an imaging element, which outputs a taken image obtained by taking an optical image transmitted through an imaging optical system, are fixed and which moves a position of the imaging element in directions perpendicular to an optical axis of the imaging optical system, a drive portion that moves the moving portion, a fixing portion to which the other of the magnetism generating portion and the magnetism detecting portion is fixed and which is fixed to an imaging device body, a first temperature detection sensor that detects a temperature of the magnetism generating portion and outputs a detection result as a first temperature, and a second temperature detection sensor that detects a temperature of the magnetism detecting portion and outputs a detection result as a second temperature. The control method comprises processing for performing control to move the moving portion by the drive portion on the basis of a moving distance of the imaging element derived on the basis of a detection result of the magnetism detecting portion, the first temperature, and the second temperature.

A non-transitory computer readable recording medium storing a program according to an eighth aspect causes a computer, which controls an imaging device, to perform processing. The imaging device includes a magnetism generating portion, a magnetism detecting portion that detects magnetism generated by the magnetism generating portion, a moving portion to which one of the magnetism generating portion and the magnetism detecting portion and an imaging element, which outputs a taken image obtained by taking an optical image transmitted through an imaging optical system, are fixed and which moves a position of the imaging element in directions perpendicular to an optical axis of the imaging optical system, a drive portion that moves the moving portion, a fixing portion to which the other of the magnetism generating portion and the magnetism detecting portion is fixed and which is fixed to an imaging device body, a first temperature detection sensor that detects a temperature of the magnetism generating portion and outputs a detection result as a first temperature, and a second temperature detection sensor that detects a temperature of the magnetism detecting portion and outputs a detection result as a second temperature. The non-transitory computer readable recording medium storing a program causes the computer to perform processing for performing control to move the moving portion by the drive portion on the basis of a moving distance of the imaging element derived on the basis of a detection result of the magnetism detecting portion, the first temperature, and the second temperature.

According to the disclosure, camera shake can be accurately corrected in a case where imaging is performed.

### BRIEF DESCRIPTION OF THE DRAWINGS

FIG. 1 is a block diagram showing an example of the hardware configuration of an imaging device according to an embodiment.

FIG. 2 is a conceptual diagram showing an example of contents stored in a secondary storage unit of a body-side main controller that is included in an imaging device body of the embodiment.

FIG. 3A is a front view showing an example of configuration, which relates to camera shake correction, of the imaging device according to the embodiment.

FIG. 3B is a perspective view showing an example of the configuration, which relates to camera shake correction, of the imaging device according to the embodiment.

FIG. 3C is a perspective view showing an example of the configuration, which relates to camera shake correction, of the imaging device according to the embodiment.

FIG. 4 is a circuit diagram showing an example of a circuit unit of the embodiment.

FIG. 5 is a diagram illustrating offset correction during adjustment.

FIG. 6 is a diagram illustrating offset correction during imaging.

FIG. 7 is a flowchart showing an example of camera shake correction-control processing that is performed by the body-side main controller of the embodiment.

### DESCRIPTION OF THE PREFERRED EMBODIMENTS

Examples of an embodiment of the technique of the disclosure will be described in detail below with reference to the drawings.

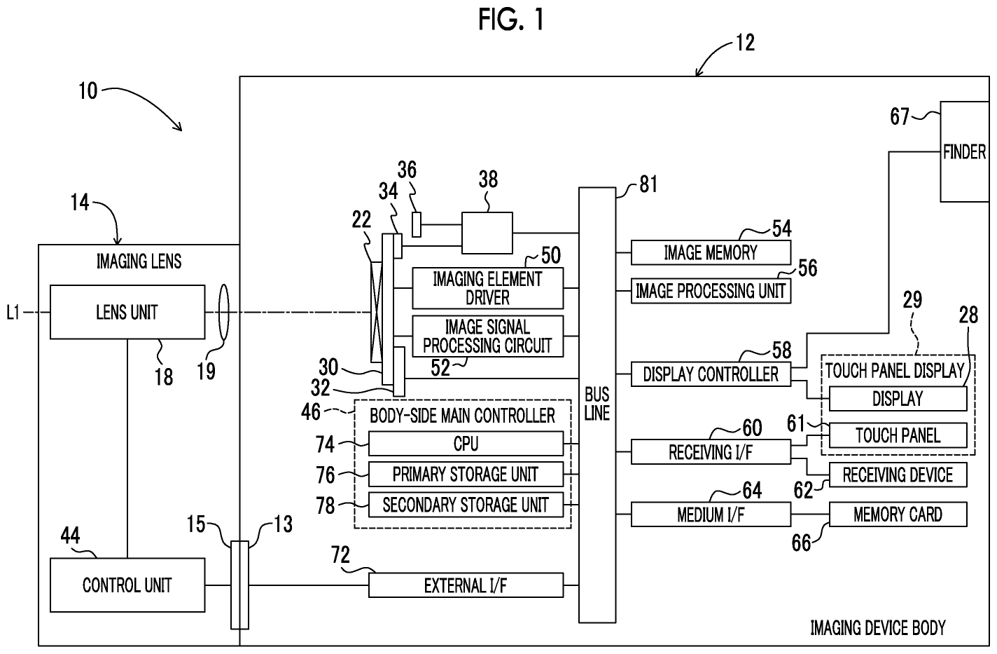

First, the configuration of an imaging device 10 according to this embodiment will be described. As shown in FIG. 1, the imaging device 10 is a lens-interchangeable digital camera and includes an imaging device body 12 and an imaging lens 14. The imaging lens 14 is mounted on the imaging device body 12 so as to be interchangeable.

A static image pickup mode in which a static image is recorded and a video pickup mode in which a video is recorded are selectively set in the imaging device 10 according to an instruction that is given to the imaging device 10 from a user. Further, a manual focus mode and an autofocus mode are selectively set in the static image pickup mode according to an instruction that is given to the imaging device 10 from a user. Autofocus will be referred to as “AF (AutoFocus)” below.

In the AF mode, imaging conditions are adjusted in a case where a release button (not shown) provided on the imaging device body 12 is made to be in a half-pressed state. Then, in a case where the release button is continuously made to be in a fully-pressed state, main exposure is performed. That is, in a case where the release button is made to be in the half-pressed state, an exposure state is set by the action of an AutoExposure (AE) function and focusing is then controlled by the action of an AF function. In a case where the release button is made to be in the fully-pressed state, imaging is performed.

The imaging device body 12 comprises a mount 13, and the imaging lens 14 comprises a mount 15. The mount 15 is joined to the mount 13, so that the imaging lens 14 is mounted on the imaging device body 12 so as to be interchangeable. The imaging lens 14 includes a lens unit 18, a stop 19, and a control unit 44. The stop 19 is provided to be closer to the imaging device body 12 than the lens unit 18, adjusts the amount of subject light transmitted through the lens unit 18, and guides the subject light into the imaging device body 12. The control unit 44 is electrically connected to the imaging device body 12 through the mounts 13 and 15, and controls the entire imaging lens 14 according to an instruction output from the imaging device body 12.

The imaging device body 12 includes an imaging element 22, a body-side main controller 46, an imaging element driver 50, an image signal processing circuit 52, an image memory 54, an image processing unit 56, and a display controller 58. Further, the imaging device body 12 includes a receiving interface (I/F) 60, a receiving device 62, a medium I/F 64, and an external I/F 72. Furthermore, the imaging device body 12 includes drive units (drive portions) 32, Hall elements 34, magnets 36, and a circuit unit (circuit portion) 38.

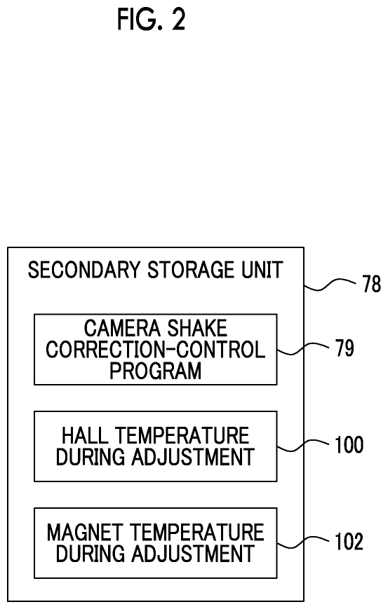

The body-side main controller 46 is an example of a computer according to the technique of the disclosure, and comprises a central processing unit (CPU) 74, a primary storage unit (storage portion) 76, and a secondary storage unit 78. The CPU 74 controls the entire imaging device 10. The primary storage unit 76 is a volatile memory that is used as a work area and the like during the execution of various programs. Examples of the primary storage unit 76 include a random access memory (RAM). The secondary storage unit 78 is a non-volatile memory that stores various programs including a camera shake correction-control program, various parameters, and the like in advance. Examples of the secondary storage unit 78 include a flash memory. As shown in FIG. 2, the camera shake correction-control program 79, a Hall temperature 100 during adjustment that will be described in detail later and is the temperature of the Hall element 34 measured in advance, and a magnet temperature 102 during adjustment that is the temperature of the magnet 36 measured in advance are stored in the secondary storage unit 78 of this embodiment in advance.

The CPU 74 reads out the camera shake correction-control program 79 from the secondary storage unit 78, develops the camera shake correction-control program 79 in the primary storage unit 76, and performs camera shake correction-control processing, which will be described in detail later, according to the developed camera shake correction-control program 79. In other words, the CPU 74 operates as a detection unit and a controller of the disclosure by executing the camera shake correction-control program 79. The camera shake correction-control program 79 of this embodiment is an example of a program of the disclosure.

The CPU 74, the primary storage unit 76, and the secondary storage unit 78 are connected to a bus line 81. Further, the imaging element driver 50 and the image signal processing circuit 52 are also connected to the bus line 81. Furthermore, the drive units 32, the circuit unit 38, the image memory 54, the image processing unit 56, the display controller 58, the receiving I/F 60, the medium I/F 64, and the external I/F 72 are also connected to the bus line 81.

The imaging element driver 50 is connected to the imaging element 22. A charge coupled device (CCD) image sensor is used as the imaging element 22 in this embodiment, but the technique of the disclosure is not limited thereto. For example, other image sensors, such as a complementary metal-oxide-semiconductor (CMOS) image sensor, may be used.

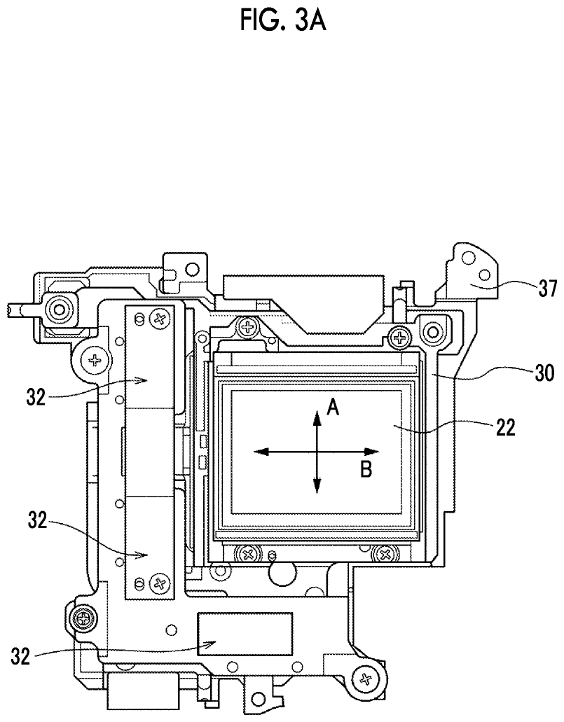

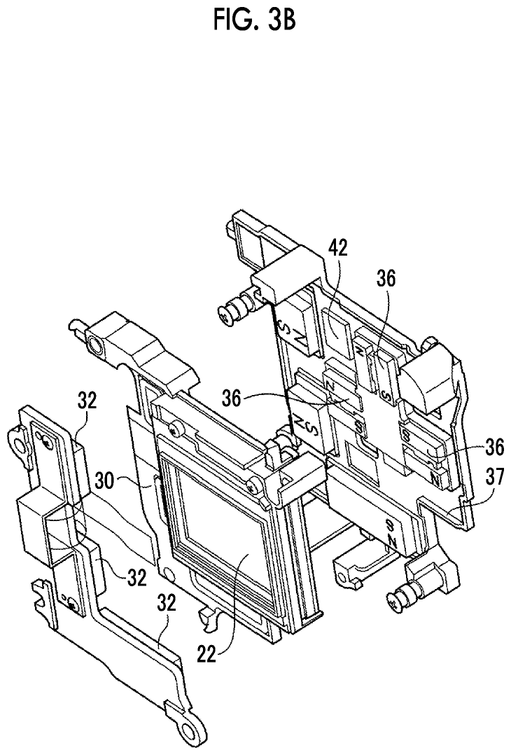

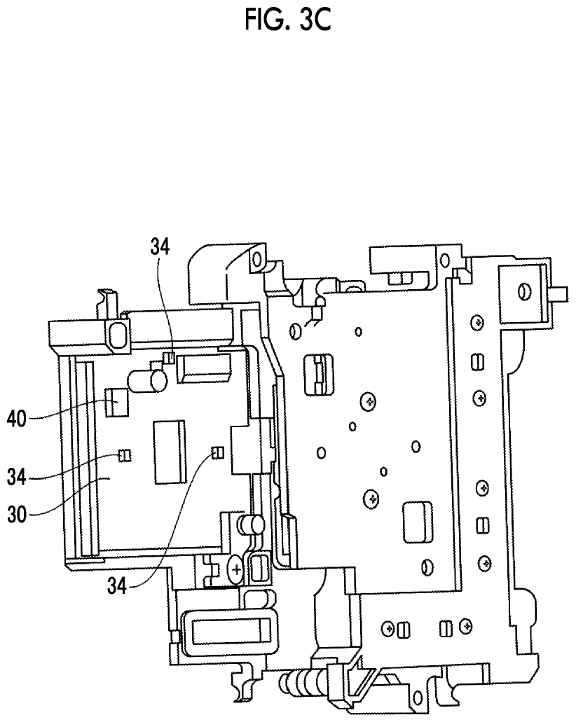

As shown in FIGS. 1 and 3A to 3C, the imaging element 22 of this embodiment is fixed to a substrate 30. The substrate 30 is driven in directions (in FIG. 3A, the direction of an arrow A and the direction of an arrow B) perpendicular to an optical axis L1 according to the drive of the drive units 32. Since the substrate 30 is driven, the imaging element 22 fixed to the substrate 30 is moved in the directions perpendicular to the optical axis L1. The substrate 30 is an example of a moving part (moving portion) of the disclosure. Three voice coil motors (VCMs) are applied as the drive units 32 in this embodiment by way of example. However, the drive units 32 are not particularly limited thereto, and have only to be capable of driving the substrate 30 in the directions perpendicular to the optical axis L1.

In the imaging device 10 according to this embodiment, the drive units 32 move the substrate 30 in the directions perpendicular to the optical axis L1, so that camera shake correction is performed.

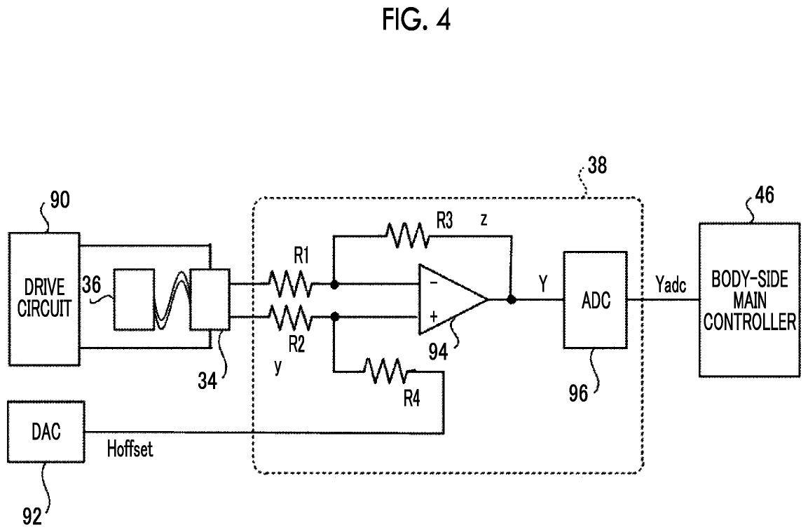

Further, as shown in FIGS. 1 and 3C, three Hall elements 34 used to detect the position of the substrate 30 (the imaging element 22) are fixed to the surface (hereinafter referred to as a “back”) of the substrate 30 opposite to the surface of the substrate 30 to which the imaging element 22 is fixed. The Hall elements 34 of this embodiment are driven by a drive circuit 90 (see FIG. 4).

Furthermore, a temperature sensor 40 used to detect the temperature of the Hall element 34 is fixed to the back of the substrate 30 as shown in FIG. 3C. With regard to the detection of the temperature of the Hall element 34, the temperature sensor 40 may be made to come into contact with the Hall element 34 to directly detect the temperature of the Hall element 34 or the temperature sensor 40 may be used to detect temperature in the vicinity of the Hall element 34 to indirectly detect the temperature of the Hall element 34. The detection result of the temperature sensor 40 is output to the body-side main controller 46 through the bus line 81. The detection result of the Hall element 34 is output to the circuit unit 38 to be described in detail later. The Hall element 34 of this embodiment is an example of a magnetism detecting part (magnetism detecting portion) of the disclosure. The temperature sensor 40 of this embodiment is an example of a second temperature detecting part (second temperature detection sensor) of the disclosure.

Further, as shown in FIGS. 1 and 3A to 3C, a fixing part (fixing portion) 37 is provided at a position facing the substrate 30 on the back side of the substrate 30. Three magnets 36 are fixed to the fixing part 37 at positions corresponding to the respective three Hall elements 34. Furthermore, since the fixing part 37 is fixed to the imaging device body 12, the position of the fixing part 37 with respect to the imaging device body 12 is fixed regardless of the movement of the substrate 30. In addition, a temperature sensor 42 used to detect the temperature of the magnet 36 is fixed to the fixing part 37 as shown in FIG. 3B. With regard to the detection of the temperature of the magnet 36, the temperature sensor 42 may be made to come into contact with the magnet 36 to directly detect the temperature of the magnet 36 or the temperature sensor 42 may be used to detect a temperature in the vicinity of the magnet 36 to indirectly detect the temperature of the magnet 36. The detection result of the temperature sensor 42 is output to the body-side main controller 46 through the bus line 81. The magnet 36 of this embodiment is an example of a magnetism generating part (magnetism generating portion) of the disclosure. Further, the temperature sensor 42 of this embodiment is an example of a first temperature detecting part (first temperature detection sensor) of the disclosure.

The Hall elements 34 are fixed to the substrate 30, but the magnets 36 may be fixed to the substrate 30. That is, one of the magnets 36 and the Hall elements 34 have only to be fixed to the substrate 30. In a case where the magnets 36 are fixed to the substrate 30, the Hall elements 34 are fixed to the fixing part 37. Further, three Hall elements 34 and three magnets 36 are provided, but each of the numbers thereof are not limited to three.

The image signal processing circuit 52 reads out image signals, which correspond to one frame, from the imaging element 22 for each pixel according to a horizontal synchronization signal. The image signal processing circuit 52 performs various types of processing, such as correlative double sampling processing, automatic gain adjustment, and analog/digital (A/D) conversion, on the read image signals. The image signal processing circuit 52 outputs the image signals, which are digitized by various types of processing performed on the image signals, to the image memory 54 for each frame at a specific frame rate (for example, several tens of frames/s) that is prescribed according to a clock signal supplied from the CPU 74.

The image memory 54 temporarily keeps the image signals that are input from the image signal processing circuit 52.

The image processing unit 56 acquires image signals from the image memory 54 for each frame at a specific frame rate, and performs various types of processing, such as gamma correction, luminance conversion, color difference conversion, and compression processing, on the acquired image signals. Further, the image processing unit 56 outputs the image signals, which are obtained through the various types of processing, to the display controller 58 for each frame at a specific frame rate. Furthermore, the image processing unit 56 outputs the image signals, which are obtained through the various types of processing, to the CPU 74 in response to the request of the CPU 74.

The display controller 58 is connected to a display 28 of a touch panel display 29 and a finder 67, and controls the display 28 and the finder 67 under the control of the CPU 74. Further, the display controller 58 outputs the image signals, which are input from the image processing unit 56, to the display 28 and the finder 67 for each frame at a specific frame rate.

The display 28 displays an image, which is represented by the image signals input from the display controller 58 at a specific frame rate, as a live view image. Furthermore, the display 28 also displays a static image that is a single frame image obtained from imaging with a single frame. A playback image, a menu screen, and the like are displayed on the display 28 in addition to the live view image. The finder 67 is a so-called electronic viewfinder, and displays an image, which is represented by the image signals input from the display controller 58 at a specific frame rate, as a live view image as with the display 28.

The receiving device 62 includes a dial, the release button, a cross key, and the like, and receives various instructions given by a user.

A touch panel 61 of the touch panel display 29 and the receiving device 62 are connected to the receiving I/F 60, and output instruction content signals, which represent the contents of received instructions, to the receiving I/F 60. The receiving I/F 60 outputs the input instruction content signals to the CPU 74. The CPU 74 performs processing corresponding to the instruction content signals that are input from the receiving I/F 60.

A memory card 66 is attachably and detachably connected to the medium I/F 64. The medium I/F 64 records an image file in the memory card 66 and reads out an image file from the memory card 66 under the control of the CPU 74. Under the control of the CPU 74, the image file, which is read out from the memory card 66 by the medium I/F 64, is subjected to decompression processing by the image processing unit 56 and is displayed on the display 28 as a playback image.

Next, the configuration, which derives the amount of camera shake, that is, the moving distance of the substrate 30, of the imaging device 10 according to this embodiment will be described. FIG. 4 shows an example of the circuit unit 38 of this embodiment. The circuit unit 38 of this embodiment is an offset circuit that performs offset correction on the detection results of the Hall elements 34. The circuit unit 38 comprises a differential amplifier 94, resistive elements R1 to R4, and an analog-to-digital converter (ADC).

An inverting input terminal of the differential amplifier 94 is connected to each Hall element 34 through the resistive element R1, and a Hall voltage is input to the inverting input terminal from the Hall element 34. Further, the inverting input terminal of the differential amplifier 94 and an output are connected to each other through the resistive element R3. On the other hand, a non-inverting input terminal of the differential amplifier 94 is connected to each Hall elements 34 through the resistive element R2, and a Hall voltage is input to the non-inverting input terminal from the Hall element 34. Further, a digital-to-analog converter (DAC) 92 is connected to the non-inverting input terminal of the differential amplifier 94 through the resistive element R4, and an offset voltage Hoffset is input to the non-inverting input terminal from the DAC 92.

The differential amplifier 94 outputs a voltage Y, which is amplified from a Hall voltage y of the Hall element 34 according to an amplification factor z, to the ADC 96. Here, the Hall voltage y is a voltage that depends on the Hall element 34 and the temperature of the magnet 36. The input voltage Y of the ADC 96 is a Hall voltage that has been subjected to offset correction using the offset voltage Hoffset.

The ADC 96 converts the input voltage Y to a digital value from an analog value, and outputs a converted value Yadc to the body-side main controller 46. The body-side main controller 46 derives a driving distance, by which the substrate 30 (the imaging element 22) is to be driven to correct camera shake, on the basis of the converted value Yadc input from the ADC 96 and the detection results of the respective temperature sensors 40 and 42; and drives the substrate 30 by the drive unit 32.

The circuit unit 38 comprises the ADC 96 in this embodiment, but it goes without saying that the ADC 96 may be provided outside the circuit unit 38.

Next, the action of the imaging device 10 according to this embodiment, specifically, an action relating to the control of camera shake correction and a control method will be described.

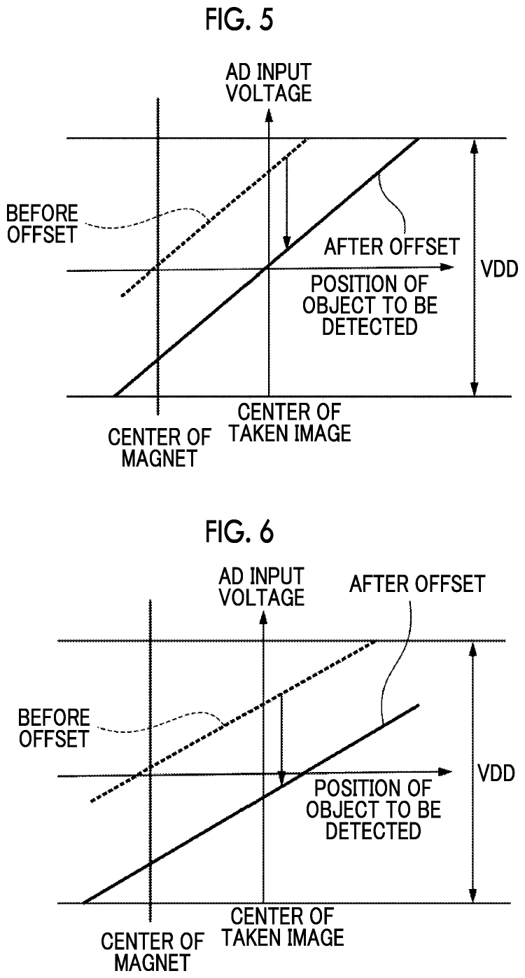

As described above, the offset correction of the Hall voltages output from the Hall elements 34 is performed by the circuit unit 38 in the imaging device 10 according to this embodiment. For this reason, in the imaging device 10 according to this embodiment, offset correction is performed on the basis of the temperatures detected by the respective temperature sensors 40 and 42 at a predetermined timing when adjustment is performed, such as before shipment, and an offset voltage Hoffset required to perform the offset correction to a state where an output is “0” at the center of a taken image as shown in FIG. 5 is acquired. In this embodiment, in a case where an adjustment is made, a temperature T1 detected by the temperature sensor 40 is stored in the secondary storage unit 78 as the Hall temperature 100 during adjustment in advance. The temperature T1 of this embodiment is an example of a fourth temperature of the disclosure. Further, in a case where an adjustment is made, a temperature T2 detected by the temperature sensor 42 is stored in the secondary storage unit 78 as the magnet temperature 102 during adjustment in advance. The temperature T2 of this embodiment is an example of a third temperature of the disclosure.

In a case where imaging is actually performed after the shipment of the imaging device 10, the temperatures of the Hall element 34 and the magnet 36 may be different from temperatures at a point of time when the offset voltage Hoffset is acquired. Particularly, the temperature of the Hall element 34 provided near the imaging element 22 and the drive unit 32 tends to rise according to heat generated from the imaging element 22 or the drive unit 32, and tends to be higher than the temperature of the magnet 36 fixed to the fixing part 37. Each of the magnetic flux sensitivity of the Hall element 34 and the residual magnetic flux density of the magnet 36 changes depending on temperature. Specifically, each of the magnetic flux sensitivity of the Hall element 34 and the residual magnetic flux density of the magnet 36 is lowered as temperature rises. In a case where the temperature of the Hall element 34 is higher than that of the magnet 36, the magnetic flux sensitivity of the Hall element 34 is more rapidly lowered than the residual magnetic flux density of the magnet 36.

For this reason, even though offset correction is performed using the offset voltage Hoffset, an output does not become “0” at the center of a taken image as shown in FIG. 6 despite the offset correction.

The offset correction is deviated due to a change in the temperatures of the Hall elements 34 and the magnets 36 as described above. Accordingly, the body-side main controller 46 of the imaging device 10 according to this embodiment derives the moving distance of the substrate 30, which is moved due to camera shake, and performs camera shake correction using the detection result (Hall voltage) of the Hall element 34, the actual temperature of the Hall element 34 (the detection result of the temperature sensor 40) obtained in a case where imaging is performed, and the temperature of the magnet 36 (the detection result of the temperature sensor 42).

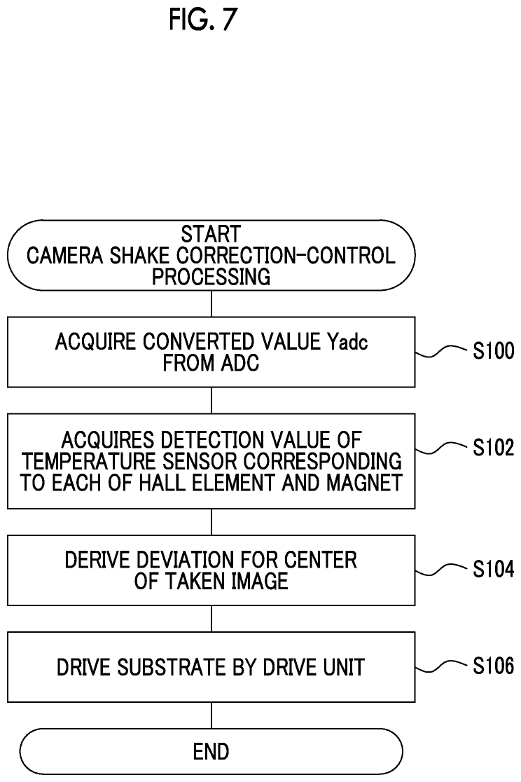

A control method and camera shake correction-control processing performed by the body-side main controller 46 will be described with reference to the drawings. In a case where the CPU 74 of the body-side main controller 46 of this embodiment performs the camera shake correction-control program 79, the body-side main controller 46 functions as a controller of the disclosure and camera shake correction-control processing of which an example is shown in FIG. 7 is performed. For example, in a case where a user instructs the camera shake correction to be performed, the body-side main controller 46 performs the camera shake correction-control processing shown in FIG. 7 in this embodiment.

In Step S100 shown in FIG. 7, the body-side main controller 46 acquires the converted value Yadc from the ADC 96.

In the next step S102, the body-side main controller 46 acquires the current temperature t1 of the magnet 36 from the temperature sensor 42 as a detection result and acquires the current temperature t2 of the Hall element 34 from the temperature sensor 40 as a detection result. In this step, the detection result of the temperature sensor 40 is an example of a second temperature of the disclosure and the detection result of the temperature sensor 42 is an example of a first temperature of the disclosure.

In the next step S104, the body-side main controller 46 derives the amount of deviation for the center of a taken image. First, the body-side main controller 46 acquires the Hall temperature 100 during adjustment (the temperature T1) and the magnet temperature 102 during adjustment (the temperature T2) from the secondary storage unit 78.

Then, the body-side main controller 46 derives a total reduction rate a of the sensitivity of the Hall element 34 and the magnetic flux density of the magnet 36 using Equation (1) on the basis of the temperatures t1, t2, T1, and T2, a temperature coefficient A1 of the Hall element 34, and a temperature coefficient A2 of the magnet 36.

a=[1+A1×(t1−T1)]×[1+A2×(t2−T2)] (1)

The current Hall voltage y is expressed by Equation (2) on the basis of the total reduction rate and a Hall output voltage x that is obtained in a case where the above-mentioned adjustment is made. The input voltage Y is expressed by Equation (3). However, Z of Equation (3) denotes the amplification factor of the differential amplifier 94.

y=(1+a)×x (2)

Y=Z×y+Hoffset (3)

Equation (4) is obtained from Equation (2) and Equation (3).

Y=Z×(1+a)×x+Hoffset (4)

An offset voltage Hoffset is determined by the adjustment in a state where the input voltage Y of the ADC 96 at the center of a taken image coincides with the center of the full range (VDD) of the ADC 96. Accordingly, Equation (5) is obtained in a case where “Y=VDD÷2”, “a=0”, and “x=L” are put in Equation (4). L is a Hall voltage that is obtained from the adjustment in a case where the imaging element 22 is present at the center of the taken image. The Hall voltage L is a value that is correlated with the mounting tolerance (mechanical tolerance) of the imaging element 22.

VDD÷2=Z×L+Hoffset

Hoffset=VDD÷2−Z×L (5)

The full range VDD of the ADC 96 and the amplification factor Z of the differential amplifier 94 are design values and are fixed values. Accordingly, in a case where the offset voltage Hoffset is stored, the Hall voltage L can be calculated from Equation (6).

L=(Hoffset−VDD÷2)÷Z (6)

The input voltage Y is derived from Equation (4) and Equation (5) by Equation (7).

Y=Z×(1+a)×x+VDD÷2−Z×L (7)

In a case where the input voltage Y is input to the ADC 96, the converted value Yadc is obtained from Equation (8). FS of Equation (8) denotes the maximum value of an AD value that is determined depending on the bit number of the ADC 96.

Yadc=Y×FS÷VDD (8)

The converted value Yadc is expressed from Equation (7) and Equation (8) by Equation (9). Accordingly, the Hall voltage x is obtained from Equation (10).

Yadc=[Z×(1+a)×x+VDD÷2−Z×L]×FS÷VDD (9)

x=[Yadc÷(Z×FS÷VDD)−VDD÷(2×Z)+L]÷(1+a) (10)

In this step, a distance relative to the center of the taken image is derived by the body-side main controller 46 and corresponds to a value of x-L. Accordingly, the body-side main controller 46 derives the value of x-L from Equation (11).

x−L=[Yadc÷(Z×FS÷VDD)−VDD÷(2×Z)+L]÷(1+a)−L (11)

In the next step S106, the body-side main controller 46 drives the substrate 30 by drive units 32 on the basis of the value of x-L derived from Equation (11) in Step S104. Accordingly, the imaging element 22 is moved, so that the camera shake correction-control processing ends after the camera shake correction is performed.

In a case where the current temperatures t1 and t2 are not used unlike in this embodiment, the total reduction rate a of magnetic flux density is 0 as known from Equation (1).

As described above, the imaging device 10 according to this embodiment comprises: the magnets 36; the Hall elements 34 that detect magnetism generated by the magnets 36; the substrate 30 to which one of the magnets 36 and the Hall elements 34 and the imaging element 22, which outputs a taken image obtained by taking an optical image transmitted through an imaging optical system, are fixed and which moves the position of the imaging element 22 in directions perpendicular to the direction of the optical axis L1 of the imaging optical system; the drive units 32 that drive the substrate 30; the fixing part 37 to which the other of the magnets 36 and the Hall elements 34 are fixed and which is fixed to the imaging device body 12; the temperature sensor 42 that detects the temperature of the magnet 36 and outputs a detection result as the temperature t1; the temperature sensor 40 that detects the temperature of the Hall element 34 and outputs a detection result as the temperature t2; and the body-side main controller 46 that performs control to drive the substrate 30 by the drive units 32 on the basis of the moving distance of the imaging element 22 derived on the basis of the detection results of the Hall elements 34, the temperature t1, and the temperature t2.

As described above, in the imaging device 10 according to this embodiment, the control of the camera shake correction is performed on the basis of the current temperatures t1 and t2 at which the camera shake correction is performed. Accordingly, even in a case where the temperatures T1 and T2 during adjustment are different from the temperatures t1 and t2, camera shake can be accurately corrected.

An aspect where the Hall element 34 is applied as an example of the magnetism detecting part has been described in this embodiment. However, the magnetism detecting part is not limited to the Hall element 34 and has only to be a magnetism sensor that can detect magnetism. For example, the magnetism detecting part may be a magnetoresistive element, a magnetic impedance element, or the like.

Further, an aspect where offset correction is achieved by the circuit unit 38 has been described in this embodiment, but the invention is not limited to this embodiment. The body-side main controller 46 or the like may perform offset correction by software control.

Furthermore, various types of processing performed in a case where the CPU executes software (program) in the respective embodiments may be performed by various processors other than the CPU. A programmable logic device (PLD) that is a processor of which circuit configuration can be changed after manufacture, such as a field-programmable gate array (FPGA), a dedicated electrical circuit that is a processor having circuit configuration designed exclusively to perform specific processing, such as an application specific integrated circuit (ASIC), and the like are exemplified as the processors in this case. Further, the various types of processing may be performed by one of these various processors or may be performed by a combination of two or more same kind or different kinds of processors (for example, a combination of a plurality of FPGAs, a combination of a CPU and an FPGA, or the like). Furthermore, the hardware structures of these various processors are more specifically electrical circuit where circuit elements, such as semiconductor elements, are combined.

Further, an aspect where the camera shake correction-control program 79 is stored (installed) in the secondary storage unit 78 in advance has been described in the respective embodiments, but the invention is not limited thereto. The camera shake correction-control program 79 may be provided in the form where the camera shake correction-control program 79 is recorded in recording mediums, such as a compact disk read only memory (CD-ROM), a digital versatile disk read only memory (DVD-ROM), and a universal serial bus (USB) memory. Furthermore, the camera shake correction-control program 79 may be downloaded from an external device through a network.

An imaging device according to Additional claim 1 to be described below can be grasped from the above description.

[Additional claim 1]

An imaging device comprising:

a magnetism generating unit;

a magnetism detecting unit that detects magnetism generated by the magnetism generating unit;

a substrate to which one of the magnetism generating unit and the magnetism detecting unit and an imaging element, which outputs a taken image obtained by taking an optical image transmitted through an imaging optical system, are fixed and which moves a position of the imaging element in directions perpendicular to an optical axis of the imaging optical system;

a drive unit that moves the substrate;

a fixing plate to which the other of the magnetism generating unit and the magnetism detecting unit is fixed and which is fixed to an imaging device body;

a first temperature detection sensor that detects a temperature of the magnetism generating unit and outputs a detection result as a first temperature;

a second temperature detection sensor that detects a temperature of the magnetism detecting unit and outputs a detection result as a second temperature; and

a processor that performs control to move the substrate by the drive unit on the basis of a moving distance of the imaging element derived on the basis of a detection result of the magnetism detecting unit, the first temperature, and the second temperature.

### EXPLANATION OF REFERENCES

10: imaging device
12: imaging device body
13, 15: mount
14: imaging lens
16: focus ring
18: lens unit
19: stop
22: imaging element
28: display
29: touch panel display
30: substrate
32: drive unit
34: Hall element
36: magnet
37: fixing part
38: circuit unit
40, 42: temperature sensor
44: control unit
46: body-side main controller
50: imaging element driver
52: image signal processing circuit
54: image memory
56: image processing unit
58: display controller
60: receiving I/F
61: touch panel
62: receiving device
64: medium I/F
66: memory card
67: finder
72: external I/F
74: CPU
76: primary storage unit
78: secondary storage unit
79: camera shake correction-control program
81: bus line
90: drive circuit
92: DAC
94: differential amplifier
96: ADC
100: Hall temperature during adjustment
102: magnet temperature during adjustment
A, B: arrow
R1 to R4: resistive element

1. An imaging device comprising:
a magnetism generating portion;
a magnetism detecting portion that is provided at a position facing to and separated from the magnetism generating portion via an air layer and detects magnetism generated by the magnetism generating portion;
a moving portion to which one of the magnetism generating portion and the magnetism detecting portion and an imaging element, which outputs a taken image obtained by taking an optical image transmitted through an imaging optical system, are fixed and which moves a position of the imaging element in directions perpendicular to an optical axis of the imaging optical system;
a drive portion that moves the moving portion;
a fixing portion to which the other of the magnetism generating portion and the magnetism detecting portion is fixed and which is fixed to an imaging device body;
a first temperature detection sensor that is fixed to the fixing portion or the moving portion which the magnetism generating portion is fixed thereto, detects a temperature of the magnetism generating portion, and outputs a detection result as a first temperature;
a second temperature detection sensor that is provided at a position facing to and separated from the first temperature detection sensor via an air layer, is fixed to the moving portion or the fixing portion which the magnetism detecting portion is fixed thereto, detects a temperature of the magnetism detecting portion, and outputs a detection result as a second temperature; and
a controller that performs control to move the moving portion by the drive portion on the basis of a moving distance of the imaging element derived by using a detection result of the magnetism detecting portion, a magnetic flux density of the magnetism generating portion on the basis of the first temperature, and an output of the magnetism detecting portion corrected on the basis of the second temperature.

2. The imaging device according to claim 1,
wherein the controller derives the moving distance on the basis of, additionally, an amount of deviation between a position of the magnetism generating portion and a position of the magnetism detecting portion that is measured in advance.

3. The imaging device according to claim 1, further comprising:
a storage portion that stores a third temperature of the magnetism generating portion and a fourth temperature of the magnetism detecting portion which are temperatures measured respectively at a predetermined timing when imaging is not yet performed by the imaging element,
wherein the controller derives the moving distance of the moving portion on the basis of, additionally, the third temperature and the fourth temperature.

4. The imaging device according to claim 2, further comprising:
a storage portion that stores a third temperature of the magnetism generating portion and a fourth temperature of the magnetism detecting portion which are temperatures measured respectively at a predetermined timing when imaging is not yet performed by the imaging element,
wherein the controller derives the moving distance of the moving portion on the basis of, additionally, the third temperature and the fourth temperature.

5. The imaging device according to claim 1,
wherein the controller performs control to move the moving portion by the drive portion on the basis of the moving distance and an amount of deviation of a predetermined position of a center of the taken image.

6. The imaging device according to claim 2,
wherein the controller performs control to move the moving portion by the drive portion on the basis of the moving distance and an amount of deviation of a predetermined position of a center of the taken image.

7. The imaging device according to claim 3,
wherein the controller performs control to move the moving portion by the drive portion on the basis of the moving distance and an amount of deviation of a predetermined position of a center of the taken image.

8. The imaging device according to claim 4,
wherein the controller performs control to move the moving portion by the drive portion on the basis of the moving distance and an amount of deviation of a predetermined position of a center of the taken image.

9. The imaging device according to claim 1,
wherein the controller includes a circuit portion that performs offset correction on the detection result of the magnetism detecting portion on the basis of an amount of deviation between a position of the magnetism generating portion and a position of the magnetism detecting portion that is measured in advance.

10. The imaging device according to claim 2,
wherein the controller includes a circuit portion that performs offset correction on the detection result of the magnetism detecting portion on the basis of an amount of deviation between a position of the magnetism generating portion and a position of the magnetism detecting portion that is measured in advance.

11. The imaging device according to claim 3,
wherein the controller includes a circuit portion that performs offset correction on the detection result of the magnetism detecting portion on the basis of an amount of deviation between a position of the magnetism generating portion and a position of the magnetism detecting portion that is measured in advance.

12. The imaging device according to claim 4,
wherein the controller includes a circuit portion that performs offset correction on the detection result of the magnetism detecting portion on the basis of an amount of deviation between a position of the magnetism generating portion and a position of the magnetism detecting portion that is measured in advance.

13. The imaging device according to claim 5,
wherein the controller includes a circuit portion that performs offset correction on the detection result of the magnetism detecting portion on the basis of an amount of deviation between a position of the magnetism generating portion and a position of the magnetism detecting portion that is measured in advance.

14. The imaging device according to claim 6,
wherein the controller includes a circuit portion that performs offset correction on the detection result of the magnetism detecting portion on the basis of an amount of deviation between a position of the magnetism generating portion and a position of the magnetism detecting portion that is measured in advance.

15. The imaging device according to claim 7,
wherein the controller includes a circuit portion that performs offset correction on the detection result of the magnetism detecting portion on the basis of an amount of deviation between a position of the magnetism generating portion and a position of the magnetism detecting portion that is measured in advance.

16. The imaging device according to claim 8,
wherein the controller includes a circuit portion that performs offset correction on the detection result of the magnetism detecting portion on the basis of an amount of deviation between a position of the magnetism generating portion and a position of the magnetism detecting portion that is measured in advance.

17. The imaging device according to claim 1,
wherein the magnetism detecting portion is a Hall element.

18. The imaging device according to claim 1,
wherein the drive portion has a coil, and
wherein the magnetism detecting portion, the second temperature detection sensor, the coil, and the imaging element are fixed to a same substrate.

19. A control method for an imaging device, the imaging device including a magnetism generating portion, a magnetism detecting portion that is provided at a position facing to and separated from the magnetism generating portion via an air layer and detects magnetism generated by the magnetism generating portion, a moving portion to which one of the magnetism generating portion and the magnetism detecting portion and an imaging element, which outputs a taken image obtained by taking an optical image transmitted through an imaging optical system, are fixed and which moves a position of the imaging element in directions perpendicular to an optical axis of the imaging optical system, a drive portion that moves the moving portion, a fixing portion to which the other of the magnetism generating portion and the magnetism detecting portion is fixed and which is fixed to an imaging device body, a first temperature detection sensor that is fixed to the fixing portion or the moving portion which the magnetism generating portion is fixed thereto, detects a temperature of the magnetism generating portion and outputs a detection result as a first temperature, and a second temperature detection sensor that is provided at a position facing to and separated from the first temperature detection sensor via an air layer, is fixed to the fixing portion or the moving portion which the magnetism detecting portion is fixed thereto, detects a temperature of the magnetism detecting portion and outputs a detection result as a second temperature, the control method comprising:
performing control to move the moving portion by the drive portion on the basis of a moving distance of the imaging element derived by using a detection result of the magnetism detecting portion, a magnetic flux density of the magnetism generating portion on the basis of the first temperature, and an output of the magnetism detecting portion corrected on the basis of the second temperature.

20. A program for causing a computer, which controls an imaging device, to perform processing, the imaging device including a magnetism generating portion, a magnetism detecting portion that is provided at a position facing to and separated from the magnetism generating portion via an air layer and detects magnetism generated by the magnetism generating portion, a moving portion to which one of the magnetism generating portion and the magnetism detecting portion and an imaging element, which outputs a taken image obtained by taking an optical image transmitted through an imaging optical system, are fixed and which moves a position of the imaging element in directions perpendicular to an optical axis of the imaging optical system, a drive portion that moves the moving portion, a fixing portion to which the other of the magnetism generating portion and the magnetism detecting portion is fixed and which is fixed to an imaging device body, a first temperature detection sensor that is fixed to the fixing portion or the moving portion which the magnetism generating portion is fixed thereto, detects a temperature of the magnetism generating portion and outputs a detection result as a first temperature, and a second temperature detection sensor that is provided at a position facing to and separated from the first temperature detection sensor via an air layer, is fixed to the fixing portion or the moving portion which the magnetism detecting portion is fixed thereto, detects a temperature of the magnetism detecting portion and outputs a detection result as a second temperature, the process comprising:
performing control to move the moving portion by the drive portion on the basis of a moving distance of the imaging element derived by using a detection result of the magnetism detecting portion, a magnetic flux density of the magnetism generating portion on the basis of the first temperature, and an output of the magnetism detecting portion corrected on the basis of the second temperature.

21. The program of claim 20, wherein the program is stored on a non-transitory computer readable recording medium.
